(19) United States
(12) Patent Application Publication
(10) Pub. No.: US 2022/0331758 A1
(43) Pub. Date: Oct. 20, 2022

(54) Stirrer Apparatus and Method for Mixing

(71) Applicant: EKATO Ruehr- und Mischtechnik GmbH, Schopfheim (DE)

(72) Inventors: Andreas ENZ, Schopheim (DE); Wolfgang KELLER, Village Neuf (FR); Werner HIMMELSBACH, Rheinfelden (DE); Woldgang LAST, Loerrach (DE)

(21) Appl. No.: 17/760,661

(22) PCT Filed: Sep. 11, 2020
(86) PCT No.: PCT/EP2020/075442

§ 371 Date: Mar. 15, 2022

(30) Foreign Application Priority Data
Sep. 16, 2019 (DE) 10 2019 124 886.8

(51) Int. Cl. B01F 27/1123; B01F 27/091; B01F 27/1125; B01F 27/808

(52) U.S. Cl. CPC B01F 27/1123; B01F 27/091; B01F 27/1125; B01F 27/808

(57) ABSTRACT

A stirrer apparatus, in particular for a usage in crystallizers, comprises a stirrer shaft, with at least one first blade element, which is held at the stirrer shaft and is configured for a mixing of at least one material that is to be mixed, and comprises at least one second blade element, which is held at the stirrer shaft and is configured to keep at least a proximity around the stirrer shaft free from material deposit and/or encrustations,

wherein the stirrer apparatus further comprises at least one stirring blade with a front side and a rear side, which comprises the first blade element and the second blade element.

The invention concerns a stirrer apparatus according to the preamble of claim 1, a stirring system according to claim 12 and a method according to claim 15.

From the state of the art, stirrer apparatuses for crystallizers are known, which have a plurality of stirring blades, some of the stirring blades being configured for a mixing of a material that is to be mixed and others being configured for a removal of material deposit and/or encrustations from a bottom surface of a stirring container. Stirring blades which are configured for a removal of material deposit and/or encrustations are arranged in a proximity of the bottom surface for scraping the material deposit and/or the encrustations from the bottom surface, while stirring blades which are configured for a mixing of the material that is to be mixed are arranged outside the proximity so as to achieve a preferably central mixing of the material that is to be mixed.

The objective of the invention is in particular to provide a generic device with improved characteristics regarding construction. The objective is achieved according to the invention by the features of claims 1 and 15 while advantageous implementations and further developments of the invention may be gathered from the subclaims.

The invention is based on a stirrer apparatus, in particular for crystallizers, with a stirrer shaft, with at least one first blade element, which is held at the stirrer shaft and is configured for a mixing of at least one material that is to be mixed, and with at least one second blade element, which is held at the stirrer shaft and is configured to keep at least a proximity around the stirrer shaft free from material deposit and/or encrustations.

It is proposed that the stirrer apparatus has at least one stirring blade with a front side and a rear side, which comprises the first blade element and the second blade element. This in particular allows obtaining a cost-efficient and/or compact stirrer apparatus. Especially advantageously it is possible to dispense with using additional stirring blades that provide either the function of the first blade element or the function of the second blade element. In particular, it is possible to dispense with stirring blades arranged outside a proximity of a bottom surface of a stirring container within which the stirrer apparatus is arranged in at least one operating state of the stirrer apparatus. The stirrer apparatus is particularly suitable for crystallizers as in crystallizers a natural mixing of the material that is to be mixed is brought about by reaction processes within the stirring container and a reduced mixing of the material that is to be mixed can be compensated by dispensing with stirring blades arranged outside the proximity of the bottom surface.

It may be possible that the first blade element and the second blade element form subregions of the stirring blade which are different from each other and advantageously adjoin each other. For example, the second blade element may form a subregion that is arranged within the proximity around the stirrer shaft, and/or the first blade element may form a subregion that is arranged outside the proximity around the stirrer shaft. For example, the stirring blade could have within the proximity around the stirrer shaft a scraping edge for scraping off material deposit and/or encrustations and could have outside the proximity around the stirrer shaft a mixing surface for a mixing of the material that is to be mixed. Preferentially the first blade element and the second blade element are realized as a common subregion of the stirring blade, which provides both the function of the first blade element and the function of the second blade element. Advantageously the common subregion loosens material deposit and/or encrustations while mixing them at the same time with the material that is to be mixed.

A “stirrer apparatus” is in particular to mean a—preferably operational—component, in particular a structural and/or functional component, of a stirrer, in particular of a mixer and/or of an agitator, in particular for a fluid but not limited to fluids. It would be conceivable that the stirrer apparatus also comprises the entire stirrer, in particular the entire mixer and/or the entire agitator.

The stirrer apparatus may comprise precisely one stirring blade. Preferentially the stirrer apparatus comprises at least two, particularly preferentially precisely two, stirring blades which, viewed parallel to the stirrer shaft, preferably form a stirring crown with an n-fold rotational symmetry, wherein n corresponds to a number of stirring blades.

By a “stirrer shaft” is in particular an elongate element to be understood which the stirring blade is fastened on, preferably by means of a hub, and which defines a rotation axis of the stirring blade. Advantageously, in the operating state the stirrer shaft protrudes through a bottom surface of a stirring container into an inner region of the stirring container. In particular, the stirrer shaft has at least one end which is arranged in the inner region of the stirring container. Alternatively, the stirrer shaft could exit from the stirring container on a side of the stirring container that is situated opposite the bottom surface. Preferably, the stirrer shaft is aligned parallel to a gravity direction, at least in the operating state.

By a “proximity around the stirrer shaft” is preferably a spatial region to be understood which, viewed along the stirrer shaft, corresponds to a circle which is centered around the stirrer shaft and whose radius is equivalent to at least 20%, especially advantageously at least 30%, preferentially at least 40% and particularly preferentially at least 50% of a diameter of the stirring container. Preferentially the proximity around the stirrer shaft is equivalent to a region that is in the operating state over-swept by the second blade element, particularly preferentially over-swept by the stirring blade.

It may be possible that the front side and the rear side are implemented as surfaces which correspond to each other and/or are congruent with each other. Preferentially the front side and the rear side have surface areas and/or shapes differing from each other.

“Configured” is in particular to mean specifically designed and/or equipped. By an object being configured for a certain function is in particular to be understood that the object fulfills said certain function in at least one application state and/or operation state. In particular, “configured” is not to mean merely suitable.

It is furthermore proposed that the first blade element and the second blade element form the stirring blade completely. In this way, in particular saving of space and/or of weight and/or of costs and/or a simple production of the stirring blade are/is achievable. Especially advantageously it is possible to do without further blade elements for forming the stirring blade. Preferentially the common subregion of the first blade element and the second blade element comprises the entire stirring blade. As a result, the functions of the first blade element and of the second blade element may be combined in a single stirring blade, and it is possible to do without a plurality of separate subregions.

In order to improve removal of material deposit and/or encrustations by the second blade element, it is proposed that in the proximity, in a plane and in particular in any plane that is parallel to the stirrer shaft, the front side intersects with a plane extending perpendicularly to the stirrer shaft under an intersection angle of maximally 60°, advantageously maximally 55° and particularly preferably no more than 50°. Preferentially the plane that extends parallel to the stirrer shaft intersects with the stirring blade in a cross-section area of the stirring blade. A “cross-section area” of the stirring blade is in particular to mean, in this context, an intersection area of the stirring blade with the plane extending parallel to the stirrer shaft, which has a minimum surface area. In particular, the plane extending parallel to the stirrer shaft is arbitrarily displaceable within the proximity along a course direction of the stirring blade. In particular, the plane extending perpendicularly to the stirrer shaft is arbitrarily displaceable along an intersection edge of the front side with the plane extending parallel to the stirrer shaft. Preferably, viewed along the gravity direction, the front side is inclined along the rotation direction. As a result, a scraping effect of the second blade element, by which the material deposit and/or encrustations are loosened in the operating state, is advantageously augmentable.

In an implementation of the invention it is proposed that the front side and the rear side are oriented at least substantially parallel to each other. By the front side and the rear side being oriented “at least substantially parallel to each other” is preferably to be understood that orientations at least of respectively opposite-situated partial regions of the front side and the rear side differ by an angle of maximally 20°, advantageously of maximally 15°, especially advantageously of maximally 10° and preferentially of maximally 5°. In particular, in this implementation the stirring blade is realized as a ribbon-shaped, preferably plate-shaped, element. By an element being “plate-shaped” is preferably to be understood that a length and a width of a smallest imaginary rectangular cuboid just still accommodating the element are at least twice, particularly preferably at least four times, preferentially at least six times and especially preferentially at least eight times a height of the smallest imaginary rectangular cuboid. Preferably, in a view along the stirrer shaft, the front side and the rear side are inclined in the rotation direction. This in particular allows saving space and/or weight and/or costs. Especially advantageously a thickness of the stirring blade can be reduced.

In an alternative implementation of the invention it is proposed that the front side and the rear side converge, advantageously continuously, towards each other. Preferentially, in the operating state, the front side and the rear side converge toward the bottom surface. Advantageously, in a plane extending parallel to the stirrer shaft and intersecting with the stirring blade in a cross-section area, an imaginary internal angle between intersection edges of the front side and the rear side with the plane, and an imaginary prolongation of the intersection edges until they meet, is maximally 80°, especially advantageously no more than 70° and preferentially no more than 60°. This in particular allows increasing a stability of the stirring blade. Especially advantageously a lower portion of the stirring blade, which is exposed to the most intense wear, may be realized thicker than an upper portion of the stirring blade.

In regard to a cross-section area of the stirring blade, any shapes deemed expedient by someone skilled in the art would be conceivable. However, in order to further increase stability of the stirring blade and/or to simplify production, it is proposed that the stirring blade has a cross-section area that is at least substantially triangle-shaped. By a cross-section area of the stirring blade at least substantially corresponding to a shape is preferably to be understood that, in a view along a plane extending parallel to the stirrer shaft and intersecting with the stirrer blade in a cross-section area, at least 80 preferably at least 90% and preferentially 100% of a surface area of the cross-section area can be covered by at least one surface which has the shape and is arranged completely within the cross-section area. It would be conceivable that the front side and the rear side meet in an edge of the stirring blade. Preferably the front side and the rear side extend separately from each other. Preferentially the cross-section area is equivalent to a trapezoid tapering counter to the gravity direction. In a view of a plane that extends parallel to the stirrer shaft, an intersection edge of an upper side of the trapezoid, which is oriented counter to the gravity direction, has a length that is preferentially maximally 30 advantageously no more than 20% and especially advantageously no more than 10% of lengths of the intersection edges of the front side and the rear side. Preferentially the stirring blade has an underside that is situated opposite the upper side. In the view, the front side, the rear side and the underside may, for example, have intersection edges of equal lengths. Preferably, in the view the intersection edges of the front side, the rear side and the underside have different lengths. Particularly preferably the intersection edge of the underside has a greater length than the intersection edges of the front side and the rear side. Especially advantageously an end portion of the stirring blade, which is oriented along the gravity direction and is in the operating state exposed to particularly huge forces, may be realized having an increased robustness.

Beyond this it is proposed that the stirring blade has a front edge which, starting from the stirrer shaft, is bent rearwards in a radial direction. By the front edge being “bent rearwards in a radial direction, starting from the stirrer shaft” is in particular to be understood that in a view along the stirrer shaft, the front edge has at least one curvature, preferably exactly one curvature wherein, starting from the stirrer shaft, the front edge has a course direction that is opposed to the rotation direction of the stirring blade. It would also be possible that, starting from the stirrer shaft, the front edge is bent in a radial direction frontwards. Advantageously the front edge is arranged to a large extent, especially advantageously completely, within the proximity of the stirrer shaft. Preferably the second blade element comprises the front edge at least to a large extent, preferably completely. This in particular enables improvement of a scraping effect of the second blade element.

It would be conceivable that the front edge is bent rearwards by at least 30°, advantageously by at least 50° and especially advantageously by at least 70°. For further improving a scraping effect of the second blade element and/or reducing a mechanical load on the stirring blade, it is proposed that the front edge is bent rearwards by at least 90°. It would be conceivable that in a view along the stirrer shaft, the stirring blade has a spiral shape, in particular a logarithmic spiral shape, with at least one turn.

Cross-section areas of the stirring blade could differ from one another over a radial extent of the stirring blade. For example, a thickness and/or a height of the stirring blade could be inconsistent over the radial extent. For a simplified production of the stirring blade, it is proposed that cross-section areas of the stirring blade are at least substantially constant at least over a large portion of a radial extent of the stirring blade. By cross-section areas being “at least substantially constant” is in particular to be understood, in this context, that the cross-section areas are identical to one another except for tolerances that may occur during production. It would be possible that the stirring blade comprises at least two separate subregions, in which the cross-section areas are at least substantially constant. Preferentially the stirring blade comprises one contiguous subregion, in which the cross-section areas are at least substantially constant. Particularly preferably the contiguous subregion is free of end regions of the stirring blade.

It may be possible that the stirring blade has an inner radial end and an outer radial end, and is realized so as to be flat toward the two radial ends. In order to increase a radial extent of the stirring blade in a material-saving manner, it is proposed that the stirring blade has an inner radial end and an outer radial end, and is realized tapering toward the two radial ends. Preferably the stirring blade is fastened to a hub via the inner radial end. Preferentially the stirring blade ends toward the outer radial end in a tip which, in a perpendicular view onto the front side and/or rear side of the stirring blade, includes an internal angle of maximally 80°, advantageously maximally 65° and especially advantageously no more than 50°.

Moreover a stirring system, advantageously a crystallizer, is proposed, with at least one stirrer apparatus and with at least one stirring container, which the stirrer apparatus is arranged in and which has a bottom surface. Preferentially the bottom surface is realized so as to be rotationally symmetrical. Advantageously the stirring container comprises at least one side wall, which adjoins the bottom surface and extends parallel to the stirrer shaft. This in particular allows improving construction. Especially advantageously, it is possible to dispense with using separate stirring blades for a mixing of a material that is to be mixed and for a removal of material deposit and/or encrustations from the bottom surface.

The stirring blade may possibly have a front edge that extends horizontally, independently from the bottom surface. For an enhancement of the scraping effect of the stirring blade, it is proposed that the stirring blade has a front edge that extends parallel to the bottom surface, preferably also during a rotation of the stirring blade. Especially advantageously the stirring blade is arranged so as to be very close to the bottom surface, in particular with a distance between the stirring blade and the bottom surface that is at least substantially constant when viewed along the stirring blade, the distance being maximally 5 cm, preferably maximally 3 cm and preferentially no more than 1 cm.

It is also proposed that in a view along the stirrer shaft, a region over-swept by the stirring blade in at least one operating state has a diameter that is at least 50%, advantageously at least 60 of a diameter of the bottom surface. As a result, in particular thorough removal of material deposit and/or encrustations from the bottom surface is achievable. Alternatively the diameter of the region over-swept by the stirring blade could be less than 50% of the diameter of the bottom surface.

Furthermore a method for a mixing, in particular in a crystallization, is proposed in which, by means of a stirring blade, both a material that is to be mixed is mixed and a proximity around a stirrer shaft is kept free of material deposit and/or encrustations. In this way it is in particular possible to improve a construction. It is especially advantageously possible to do without using separate stirring blades and/or blade elements for the mixing of the material that is to be mixed and for the removal of material deposit and/or encrustations from the proximity.

Further advantages will become apparent from the following description of the drawings. In the drawings three exemplary embodiments of the invention are illustrated. The drawings, the description and the claims contain a plurality of features in combination. Someone skilled in the art will purposefully also consider the features separately and will find further expedient combinations.

It is shown in:

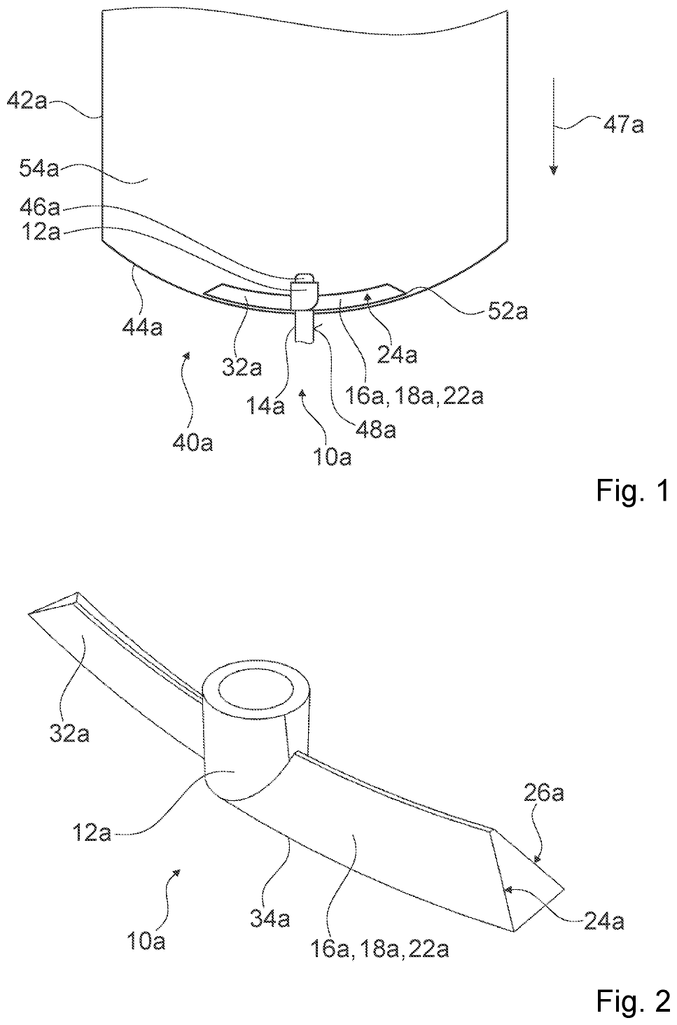

FIG. 1A schematic illustration of a stirring system with a stirrer apparatus and a stirring container,

FIG. 2 a schematic illustration of the stirrer apparatus, which a stirring blade and a further stirring blade of the stirrer apparatus are fastened on, in an isometric view,

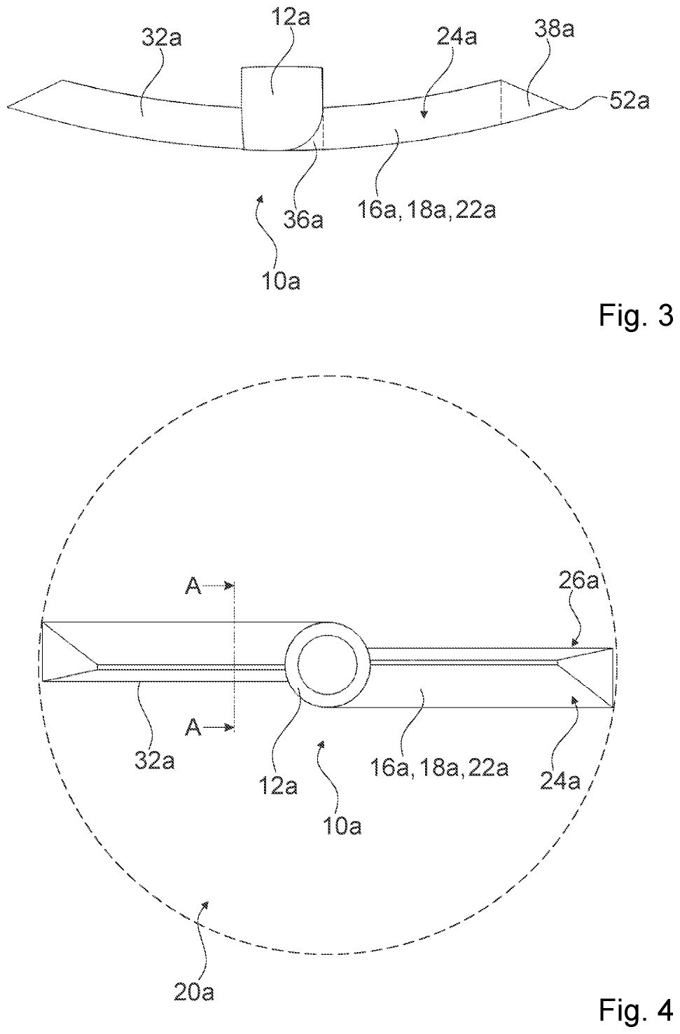

FIG. 3 a schematic illustration of the stirrer apparatus in a lateral view,

FIG. 4 a schematic illustration of the stirrer apparatus in a view from above,

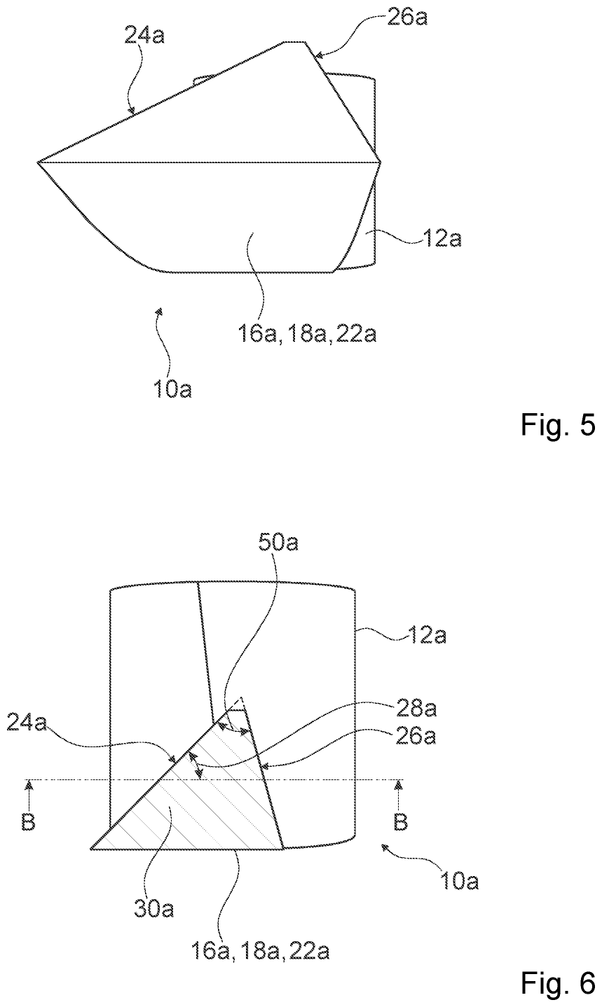

FIG. 5 a schematic illustration of the stirrer apparatus in a further lateral view,

FIG. 6 a schematic cross-sectional illustration of the stirrer apparatus in the further lateral view,

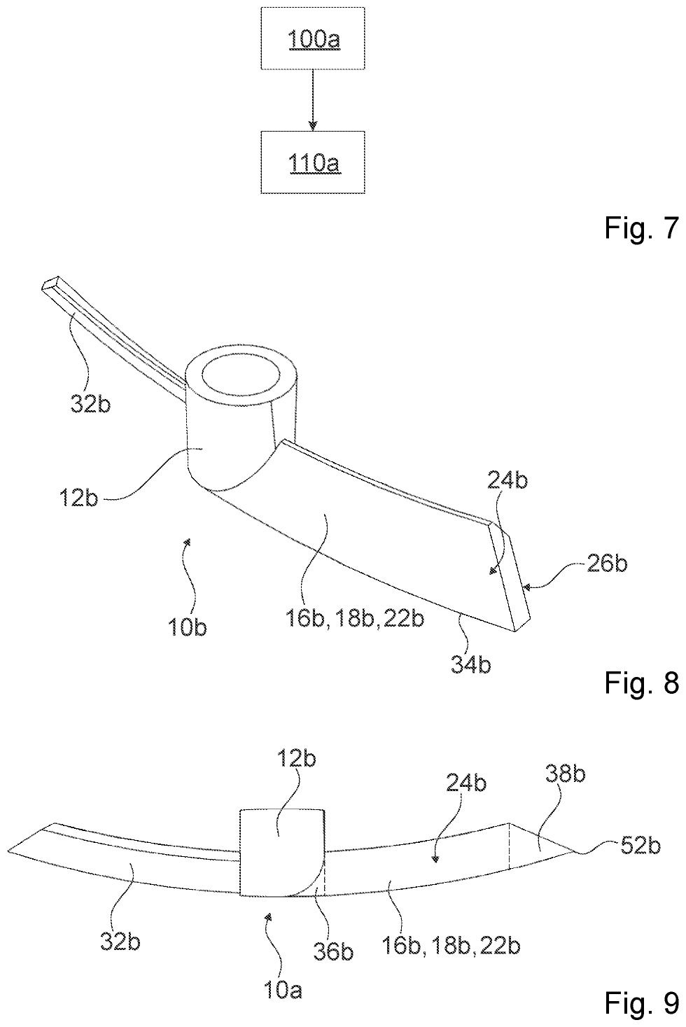

FIG. 7 a schematic flow chart of a method for a mixing by means of the stirring system,

FIG. 8 a further exemplary embodiment of a stirrer apparatus, which a stirring blade and a further stirring blade of the stirrer apparatus are fastened on, in an isometric view,

FIG. 9 a schematic illustration of the stirrer apparatus of FIG. 8 in a view onto a front side of the hub,

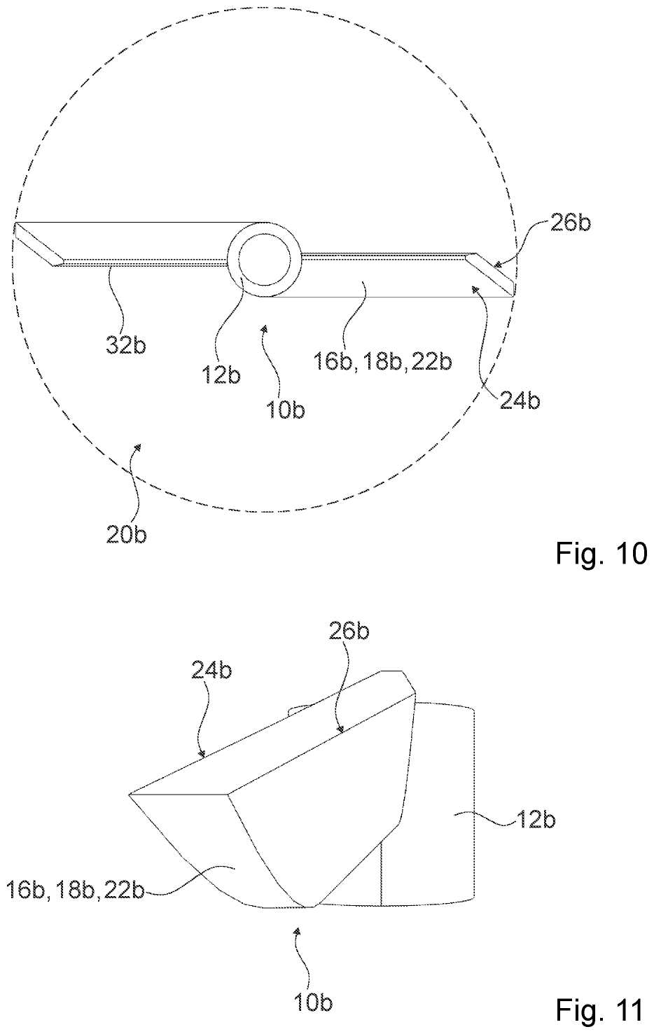

FIG. 10 a schematic illustration of the hub of the further stirrer apparatus, in a view along a stirrer shaft of the second stirrer apparatus,

FIG. 11 a schematic illustration of the hub of the further stirrer apparatus, in a view onto an outer radial end of the stirring blade of the hub,

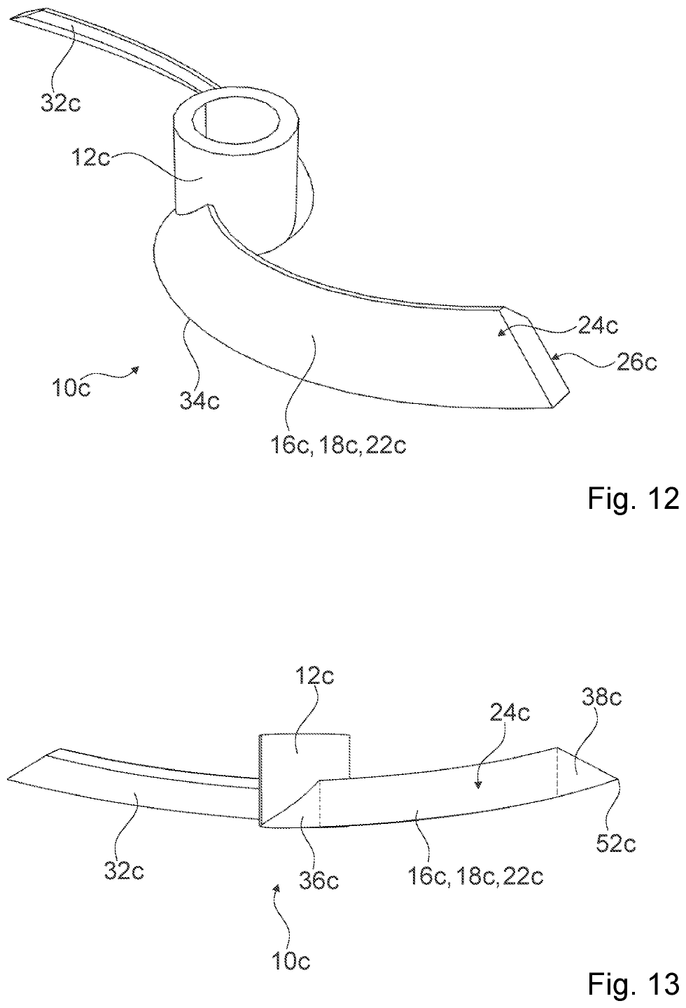

FIG. 12 a schematic illustration of a hub of a further stirrer apparatus, which a stirrer blade and a further stirrer blade are fastened on, in an oblique view,

FIG. 13 a schematic illustration of the hub of the further stirrer apparatus, in a view onto a front side of the hub,

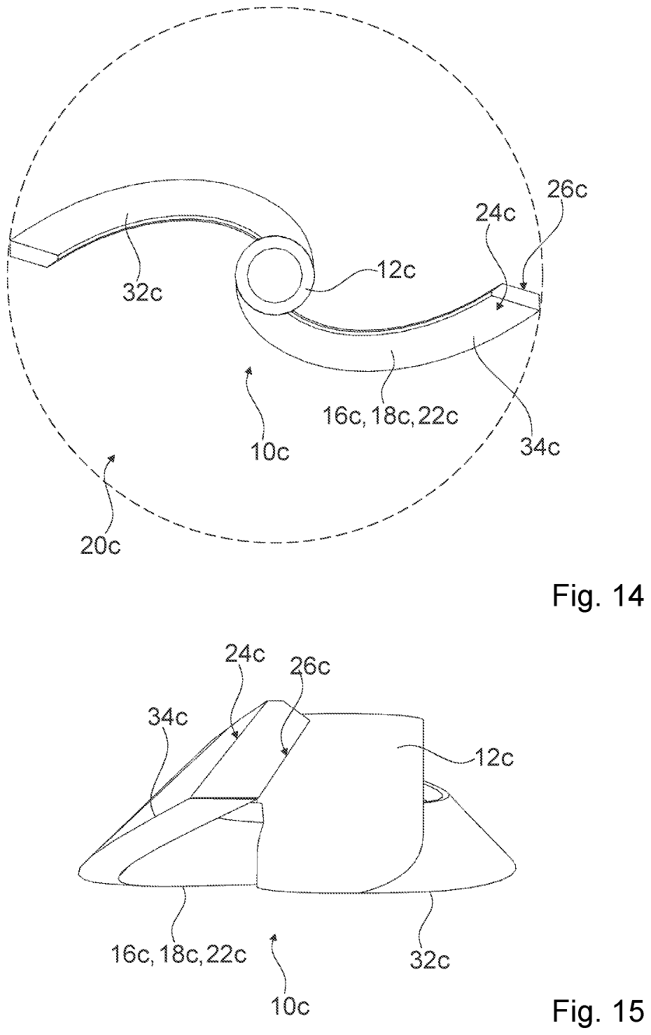

FIG. 14 a schematic illustration of the hub of the further stirrer apparatus, in a view along a stirrer shaft of the further stirrer apparatus, and

FIG. 15 a schematic illustration of the hub of the further stirrer apparatus, in a view onto an outer radial end of the stirring blade.

If there are a plurality of objects, in each case only one of such objects is provided with a reference numeral in the figures.

FIG. 1 shows part of a stirring system 40a. The stirring system 40a is realized as a crystallizer. The stirring system 40a comprises a stirring container 42a. The stirring container 42a is filled with a material that is to be mixed 54a. The stirring container 42a has a bottom surface 44a. Viewed from inside, the bottom surface 44a is realized in a concave manner. The bottom surface 44a is realized in a rotationally symmetrical manner. The stirring system 40a comprises a stirrer apparatus 10a. The stirrer apparatus 10a is arranged in the stirring container 42a. The stirrer apparatus 10a comprises a stirrer shaft 14a. The stirrer shaft 14a is guided through a recess 48a of the bottom surface 44a. The stirrer shaft 14a has an end 46a. The end 46a is oriented counter to a gravity direction 47a. The stirring container 42a comprises a sealing element (not shown), which is arranged in the recess 48a and seals an interstice (not shown) between the stirrer shaft 14a and the bottom surface 44a. The sealing element may, for example, comprise an elastomer and/or a ball bearing.

The stirrer apparatus 10a comprises a stirring blade 22a, which is fastened on the stirrer shaft 14a. The stirrer apparatus 10a comprises a further stirring blade 32a, which is also fastened on the stirrer shaft 14a. The stirring blade 22a and the further stirring blade 32a are fastened on a hub 12a of the stirrer apparatus 10a. The stirring blade 22a and the further stirring blade 32a are fastened on the hub 12a via a welding process. The further stirring blade 32a is implemented identically to the stirring blade 22a and is fastened on the hub 12a at a 180°-rotation. The hub 12a is slid onto the stirrer shaft 14a and is fastened thereon.

FIGS. 2 to 6 show different views of portions of the stirrer apparatus.

The stirring blade 22a comprises the first blade element 16a. The stirring blade 22a comprises the second blade element 18a. The first blade element 16a and the second blade element 18a form the stirring blade 22a completely. The first blade element 16a and the second blade element 18a are respectively implemented identically to the stirring blade 22a. The first blade element 16a and the second blade element 18a are realized by a common subregion, which comprises the entire stirring blade 22a. The first blade element 16a mixes the material that is to be mixed 54a. The second blade element 18a keeps a proximity 20a of the stirrer shaft 14a free from material deposit and encrustations. The stirring blade 22a has a front side 24a. The stirring blade 22a has a rear side 26a.

The proximity 20a of the stirrer shaft 14a is equivalent to a region over-swept by the stirring blade 22a, which is shown in FIG. 4. In a view along the stirrer shaft 14a, the region over-swept by the stirrer blade 22a has a diameter that is 50% of a diameter of the bottom surface 44a.

In the proximity 20a, in a plane A that extends parallel to the stirrer shaft 14a, that is shown in FIG. 4 and was used in FIG. 6 as a sectional plane, the front side 24a of the stirring blade 22a intersects with a plane B, which extends perpendicularly to the stirrer shaft B, under an intersection angle 28a of approximately 45° as illustrated in FIG. 6. Alternatively, the intersection angle 28a may have any other value below 60°. The plane A, which extends parallel to the stirrer shaft 14a, intersects with the stirring blade 22a in a cross-section area 30a.

The front side 24a and the rear side 26a converge towards each other. In the sectional view shown in FIG. 6, an imaginary internal angle 50a between the intersection edges of the front side 24a and the rear side 26a, with an imaginary prolongation of the intersection edges until they meet, is approximately 60°. Alternatively, the internal angle 50a may have any other value below 80°.

The stirring blade 22a has a cross-section area 30a, which is illustrated in FIG. 6. The cross-section area 30a is essentially triangle-shaped. The cross-section area 30a is realized as a trapezoid. The cross-section area 30a is realized tapering counter to the gravity direction 47a. In a displacement of the intersection plane perpendicularly to the stirrer shaft 14a, cross-section areas of the stirring blade 22a are identical to the cross-section area 30a over a large portion of a radial extent of the stirring blade 22a.

The stirring blade 22a has an inner radial end 36a, which is shown in detail in FIG. 3. The stirring blade 22a has an outer radial end 38a. The stirring blade 22a is implemented tapering towards the two radial ends 36a, 38a. In a displacement of the sectional plane perpendicularly to the stirrer shaft 14a between the radial ends 36a, 38a, the cross-section areas of the stirring blade 22a are identical to the cross-section area 30a. Toward the outer radial end 38a, the stirring blade 22a ends in a tip 52a.

The stirring blade 22a comprises a front edge 34a. The front edge 34a extends parallel to the bottom surface 44a, as illustrated in FIG. 1. During a rotation of the stirring blade 22a, the front edge 34a extends always parallel to the bottom surface 44a. The front edge 34a serves for scraping off material deposit and encrustations which accumulate on the bottom surface 44a.

FIG. 7 shows a schematic flow chart of a method for a mixing, in a crystallization, by way of the stirring system 40a. In the method, by means of the stirring blade 22a, both the material that is to be mixed 54a is mixed and the proximity 20a around the stirrer shaft 14a is kept free from material deposit and encrustations. In a filling step 100a the material that is to be mixed 54a is filled into the stirring container 42a. In a mixing step 110a the stirrer apparatus 10a is brought into the operating state. The mixing step 110a follows the filling step 100a.

In FIGS. 8 to 15 two further exemplary embodiments of the invention are shown. The following descriptions are limited substantially to the differences between the exemplary embodiments, wherein regarding components, features and functions that remain the same, the description of the exemplary embodiment of FIGS. 1 to 7 may be referred to. In order to distinguish between the exemplary embodiments, the letter a added to the reference numerals of the exemplary embodiment of FIGS. 1 to 7 has been replaced by the letter b in the reference numerals of the exemplary embodiment of FIGS. 8 to 11 and by the letter c in the reference numerals of the exemplary embodiment of FIGS. 12 to 15. Regarding components having the same denomination, in particular regarding components having the same reference numerals, principally the drawings and/or the description of the exemplary embodiment of FIGS. 1 to 7 may be referred to.

In FIGS. 8 to 11 portions of a stirrer apparatus 10b are shown in different views. A front side 24b and a rear side 26b of a stirring blade 22b of the stirrer apparatus 10b are oriented parallel to each other.

In FIGS. 12 to 15 portions of a stirrer apparatus 10c are shown in different views. A front side 24c and a rear side 26c of a stirring blade 22c of the stirrer apparatus 10c are oriented parallel to each other. As an alternative, the front side 24c and the rear side 26c could be oriented such that they taper toward each other. The stirring blade 22c may furthermore have an at least substantially triangular cross-section. The stirring blade 22c has a front edge 34c. Starting from a stirrer shaft 14c and in particular from a hub 12c of the stirrer apparatus 10c, the front edge 34c is bent rearwards in a radial direction, in the present case bent rearwards by 90°. Alternatively, the front edge 34c could be bent rearwards by any other angle between 90° and 180°.

### REFERENCE NUMERALS

10 stirrer apparatus
12 hub
14 stirrer shaft
16 first blade element
18 second blade element
20 proximity
22 stirring blade
24 front side
26 rear side
28 intersection angle
30 cross-section area
32 further stirring blade
34 front edge
36 inner radial end
38 outer radial end
40 stirrer system
42 stirring container
44 bottom surface
46 end
47 gravity direction
48 recess
50 internal angle
52 tip
54 material to be mixed
100 filling step
110 mixing step

1. A stirrer apparatus, in particular for crystallizers, with a stirrer shaft, with at least one first blade element, which is held at the stirrer shaft and is configured for a mixing of at least one material that is to be mixed, and with at least one second blade element, which is held at the stirrer shaft and is configured to keep at least a proximity around the stirrer shaft free from material deposit and/or encrustations by a scraping-off effect, the stirrer apparatus comprising at least one stirring blade with a front side and a rear side, which comprises the first blade element and the second blade element, wherein the proximity around the stirrer shaft is equivalent to a region that is in an operating state over-swept by the stirring blade.

2. The stirrer apparatus according to claim 1, wherein the first blade element and the second blade element form the stirring blade completely.

3. The stirrer apparatus according to claim 1, wherein in the proximity, in a plane (A) that is parallel to the stirrer shaft, the front side intersects with a plane (B), which extends perpendicularly to the stirrer shaft, under an intersection angle of maximally 60°.

4. The stirrer apparatus according to claim 1, wherein the front side and the rear side are oriented at least substantially parallel to one another.

5. The stirrer apparatus according to claim 1, wherein the front side and the rear side converge towards each other.

6. The stirrer apparatus according to claim 1, wherein the stirring blade has a cross-section area that is at least substantially triangle-shaped.

7. The stirrer apparatus according to claim 1, comprising at least one further stirring blade, which is implemented and arranged rotationally symmetrically with respect to the stirring blade.

8. The stirrer apparatus according to claim 1, wherein the stirring blade has a front edge which, starting from the stirrer shaft, is bent rearwards in a radial direction.

9. The stirrer apparatus according to claim 8, wherein the front edge is bent rearwards by at least 90°.

10. The stirrer apparatus according to claim 1, wherein cross-section areas of the stirring blade are at least substantially constant at least over a large portion of a radial extent of the stirring blade.

11. The stirrer apparatus according to claim 1, wherein the stirring blade has an inner radial end and an outer radial end, and is realized tapering toward the two radial ends.

12. A stirring system, in particular a crystallizer, with at least one stirrer apparatus according to claim 1 and with at least one stirring container which the stirrer apparatus is arranged in and which has a bottom surface.

13. The stirring system according to claim 12, wherein the stirring blade has a front edge that extends parallel to the bottom surface.

14. The stirring system according to claim 12, wherein in a view along the stirrer shaft, a region over-swept by the stirring blade in at least one operating state has a diameter that is at least 50% of a diameter of the bottom surface.

15. A method for a mixing, in particular in a crystallization, in particular with a stirrer apparatus according to claim 1 and preferably with a stirring system according to claim 12, to in which, by means of a stirring blade, both a material that is to be mixed is mixed and a proximity around a stirrer blade, which is over-swept by the stirring blade, is kept free from material deposit and/or encrustations by a scraping-off effect.
